(19) United States
(12) Patent Application Publication
(10) Pub. No.: US 2019/0347612 A1
(43) Pub. Date: Nov. 14, 2019

(54) VERIFYING CORRECT PACKAGE DELIVERY ADDRESS THROUGH GPS AND ADDRESS LABEL COORDINATION

(71) Applicant: INTERNATIONAL BUSINESS MACHINES CORPORATION, Armonk, NY (US)

(72) Inventors: Kelley L. Anders, East New Market, MD (US); Lisa Seacat DeLuca, Baltimore, MD (US); Jeremy R. Fox, Georgetown, TX (US); Jeremy A. Greenberger, San Jose, CA (US)

(21) Appl. No.: 15/978,339

(22) Filed: May 14, 2018

(51) Int. Cl. G06Q 10/08; G01S 19/42; G06Q 10/06

(52) U.S. Cl. CPC G06Q 10/0833; G06Q 10/06316; G01S 19/42

(57) ABSTRACT

A method for verifying a delivery of a package to a correct address. The method scans a package label to obtain a first set of coordinates that identifies a delivery address for a package, when a delivery person is delivering the package. The method further receives a second set of coordinates from a global positioning system to determine a current location of the delivery person. The method further compares the first set of coordinates with the second set of coordinates, and displays a notification to the delivery person to leave the package at the current location or to not leave the package at the current location.

### BACKGROUND

The present disclosure relates generally to the field of cognitive computing, data processing, and more particularly to verifying a correct package delivery address through global positioning system (GPS) coordinates and address label coordination.

With the growth of e-commerce and online retailing, package delivery service providers are in high demand. Hundreds of millions of packages are delivered on an annual basis, thus fueling a multibillion-dollar industry. The success of a package delivery service provider primarily depends on the timeliness of a delivery to a correct destination.

Oftentimes, a delivery package may mistakenly be delivered to an incorrect address. The consequences of an incorrect package delivery may lead to consumer dissatisfaction and a lower consumer confidence in the reliability of the package delivery service provider. For example, if one has plans to go away camping for the weekend and orders a tent, on a Tuesday prior to the camping trip, through an online retailer for two-day delivery, it is expected that the tent will arrive in time for the camping trip. A package delivery service provider's error in mistakenly delivering the tent to a different address may ruin one's plans and lead to a bad review for the package delivery service provider.

Currently, there is no ability for the package delivery service provider to verify that a package to be delivered is actually at the correct GPS location of the delivery address, for each and every package being delivered. A quick and efficient method to double check a delivery package with the delivery address, at the time of delivery, would be beneficial to both a consumer and a package delivery service provider.

### BRIEF SUMMARY

Embodiments of the present invention disclose a method, a computer program product, and a system.

According to an embodiment, a method, in a data processing system including a processor and a memory, for implementing a program that verifies a delivery of a package to a correct address is provided. The method scans a package label to obtain a first set of coordinates that identifies a delivery address for a package, when a delivery person is delivering the package. The method receives a second set of coordinates from a global positioning system to determine a current location of the delivery person. The method compares the first set of coordinates with the second set of coordinates, and displays a notification to the delivery person to leave the package at the current location or to not leave the package at the current location.

According to another embodiment, a computer program product for directing a computer processor to implement a program that verifies a delivery of a package to a correct address is provided. The storage device embodies program code that is executable by a processor of a computer to perform a method. The method scans a package label to obtain a first set of coordinates that identifies a delivery address for a package, when a delivery person is delivering the package. The method receives a second set of coordinates from a global positioning system to determine a current location of the delivery person. The method compares the first set of coordinates with the second set of coordinates, and displays a notification to the delivery person to leave the package at the current location or to not leave the package at the current location.

According to another embodiment, a system for implementing a program that manages a device, includes one or more computer devices each having one or more processors and one or more tangible storage devices is provided. The one or more storage devices embody a program. The program has a set of program instructions for execution by the one or more processors. The program instructions include instructions for verifying a delivery of a package to a correct address. The program instructions include instructions for scanning a package label to obtain a first set of coordinates that identifies a delivery address for a package, when a delivery person is delivering the package. The program instructions further include instructions for receiving a second set of coordinates from a global positioning system to determine a current location of the delivery person. The program instructions further include instructions for comparing the first set of coordinates with the second set of coordinates, and displaying a notification to the delivery person to leave the package at the current location or to not leave the package at the current location.

### BRIEF DESCRIPTION OF THE DRAWINGS

FIG. 1 illustrates a package delivery address verification computing environment, in accordance with an embodiment of the present invention.

FIG. 2 is a flowchart illustrating the operation of package delivery address verification program 120 of FIG. 1, in accordance with an embodiment of the present invention.

FIG. 3 is a diagram graphically illustrating the hardware components of a package delivery address verification computing environment of FIG. 1, in accordance with an embodiment of the present invention.

FIG. 4 depicts a cloud computing environment, in accordance with an embodiment of the present invention.

FIG. 5 depicts abstraction model layers of the illustrative cloud computing environment of FIG. 4, in accordance with an embodiment of the present invention.

### DETAILED DESCRIPTION

The present invention produces a positive address validation verification for the delivery person when leaving the package at the addressee's door, via GPS location matching, against customer package metadata.

For example, a person may have a package delivered to their house and, after opening it, determine that it is an incorrect product delivered to them in error. The person may sign on to the originating online retailer to return the item and, within the hour, receive the correct delivery package. However, when the person looks at both packages, he notices on the address label that the first package should have been delivered to a distant neighbor who does not even live in the same zip code or city. The package delivery service provider had delivered the wrong item to the wrong address by mistake.

The present invention seeks to avoid incorrect package deliveries by disclosing a method to combine global positioning system (GPS) locational and bar scanner technology to alert a delivery person to ensure that the package they have scanned is about to be delivered to the correct, or incorrect, address.

Hereinafter, exemplary embodiments of the present invention will be described in detail with reference to the attached drawings.

The present invention is not limited to the exemplary embodiments below, but may be implemented with various modifications within the scope of the present invention. In addition, the drawings used herein are for purposes of illustration, and may not show actual dimensions.

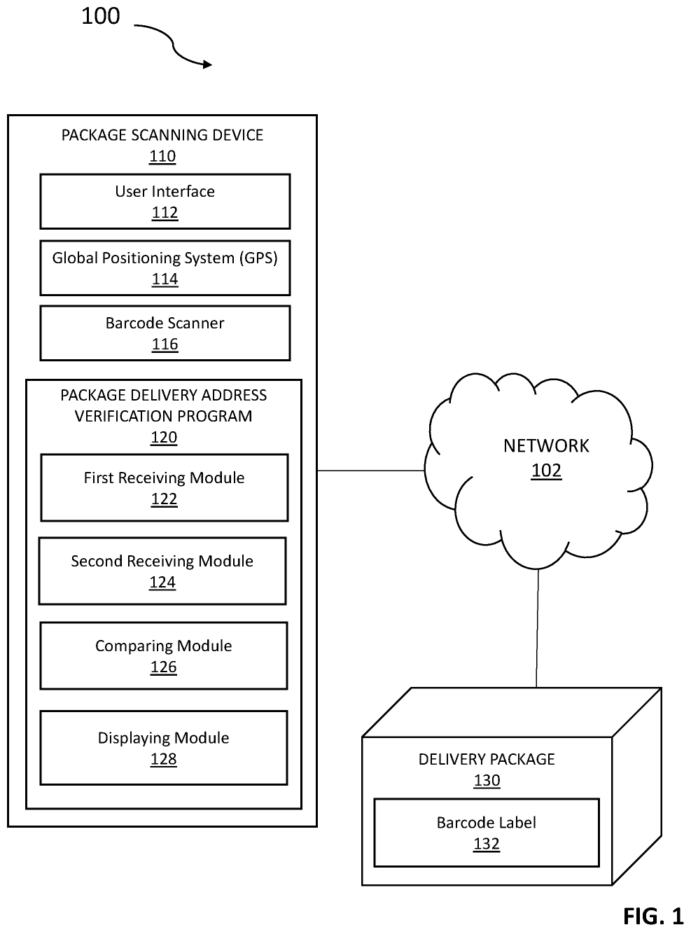

FIG. 1 illustrates package delivery address verification computing environment 100, in accordance with an embodiment of the present invention. Package delivery address verification computing environment 100 includes package scanning device 110 and delivery package 130, all connected via network 102. The setup in FIG. 1 represents an example embodiment configuration for the present invention, and is not limited to the depicted setup in order to derive benefit from the present invention.

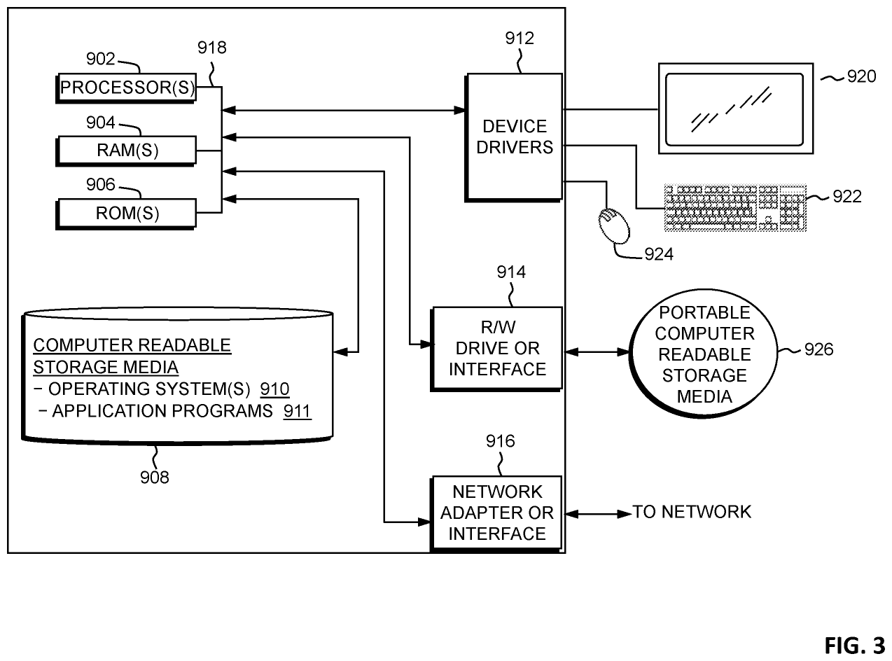

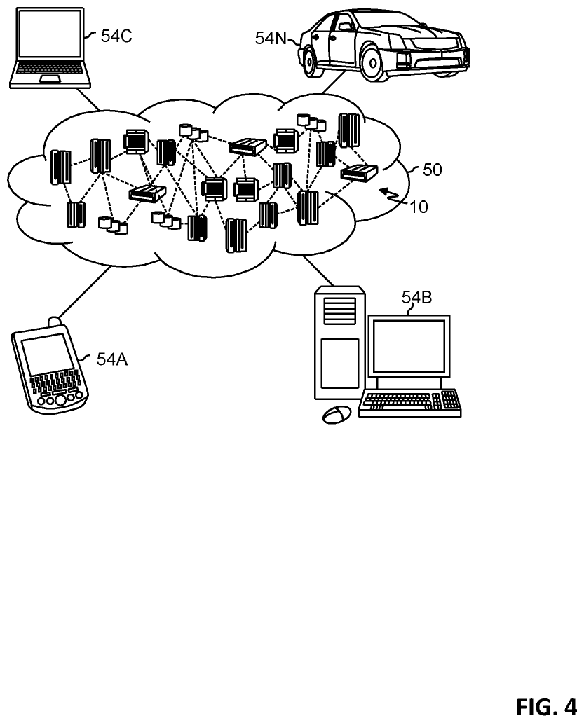

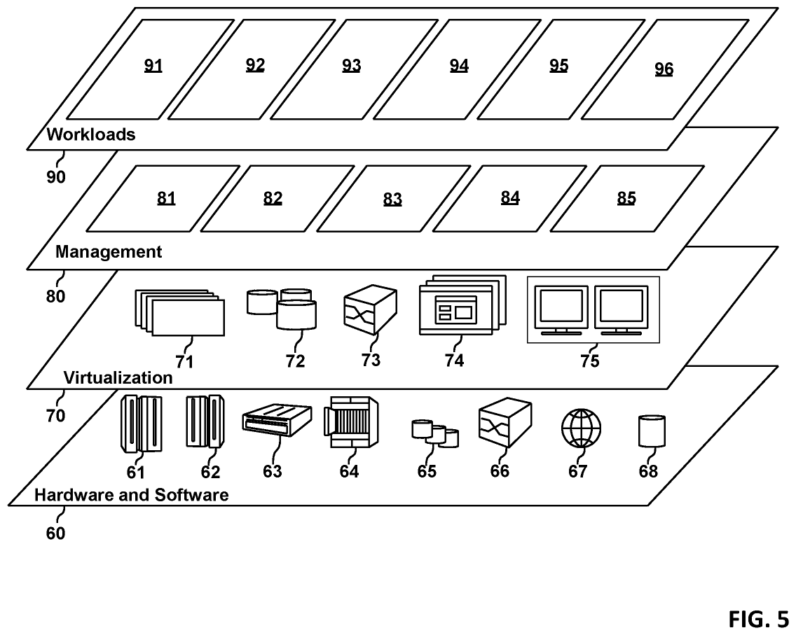

In exemplary embodiments, package scanning device 110 contains user interface 112, global positioning system (GPS) 114, barcode scanner 116, and package delivery address verification program 120. In various embodiments, package scanning device 110 may be a laptop computer, tablet computer, netbook computer, personal computer (PC), a desktop computer, a personal digital assistant (PDA), a smart phone, a delivery information acquisition device (DIAD), or any programmable electronic device capable of communicating with delivery package 130 via network 102. Package scanning device 110 may include internal and external hardware components, as depicted and described in further detail below with reference to FIG. 3. In other embodiments, package scanning device 110 may be implemented in a cloud computing environment, as described in relation to FIGS. 4 and 5, herein. Package scanning device 110 may also have wireless connectivity capabilities allowing it to communicate with delivery package 130 and other computers or servers over network 102.

In exemplary embodiments, package scanning device 110 includes user interface 112, which may be a computer program that allows a user to interact with package scanning device 110 and other connected devices via network 102. For example, user interface 112 may be a graphical user interface (GUI). In addition to comprising a computer program, user interface 112 may be connectively coupled to hardware components, such as those depicted in FIG. 3, for receiving user input. In exemplary embodiments, user interface 112 may be a web browser, however in other embodiments user interface 112 may be a different program capable of receiving user interaction and communicating with other devices.

In exemplary embodiments, GPS 114 may be a computer program on package scanning device 110 that provides time and location information for a package delivery person, or a package delivery vehicle. Modern GPS systems operate on the concept of time and location. In modern GPS systems, four or more satellites broadcast a continuous signal detailing satellite identification information, time of transmission (TOT), and the precise location of the satellite at the time of transmission. When a GPS receiver picks up the signal, it determines the difference in time between the time of transmission (TOT) and the time of arrival (TOA). Based on the amount of time it took to receive the signals and the precise locations of the satellites when the signals were sent, GPS receivers are capable of determining the location where the signals were received. In exemplary embodiments, GPS 114 may be capable of providing real-time location detection of a package delivery person, or package delivery vehicle. For example, GPS 114 may be capable of providing a set of longitudinal and latitudinal coordinates of a package delivery person, carrying package scanning device 110, who is about to scan a delivery package 130 in front of a destination address, such as a private home.

In various embodiments, GPS 114 may be capable of providing vertical height information for longitudinal and latitudinal coordinates of a package delivery person, carrying package scanning device 110, with reference to various floors in a multi-floor building, such as an apartment complex or office building.

In exemplary embodiments, barcode scanner 116 may be a computer program, on package scanning device 110, that can read and output printed barcodes, such as barcode label 132, to a computing device, such as package scanning device 110. In exemplary embodiments, barcode scanner 116 may consist of a light source, a lens, and a light sensor translating optical impulses into electrical ones. Barcode scanner 116 may contain decoder circuitry that analyzes the barcode's image data provided by the sensor and sends the barcode label's 132 content to the barcode scanner's 116 output port.

In alternative embodiments, barcode scanner 116 may be a pen-type scanner, a laser scanner, a camera-based reader, and any other known scanner technology known to one of ordinary skill in the art.

With continued reference to FIG. 1, a delivery package 130 may include a box (of various sizes), an envelope (of various sizes) or any other item that is typically sent/delivered via the postal service or via a private courier service (i.e., package delivery service provider). Some well-known courier services may provide delivery package 130 tracking services such as scanning a shipping label (i.e., barcode label 132) and uploading the tracking information to a database, or server, that may be accessed by a sender/recipient entering a tracking number via a website or portal. Tracking information may include date and time that a delivery package 130 is received at various distribution centers, loaded/unloaded to a delivery vehicle (e.g., a truck, car, airplane), and so forth.

In exemplary embodiments, delivery package 130 contains a barcode label 132. A barcode label 132 may be a symbol, or a machine readable representation of data, which carries information about the object or address to which it is attached. Barcode printing uses different combinations of bars and spaces to encode data into barcodes that are printed on a label or a card. Barcodes can be one-dimensional or two-dimensional, and they can be read by special optical scanners or barcode readers, such as barcode scanner 116, desktop printers, and smart phones.

In exemplary embodiments, barcode label 132 contains unique information pertaining to a specific delivery package 130 such as a recipient's name, a delivery address that includes street name, city, state, and zip code, embedded GPS longitudinal and latitudinal coordinates for a delivery address, and elevation coordinates if the delivery address is located within a multi-floor building. Barcode label 132 may also contain additional data such as weight of delivery package 130, item description, tracking information, and so forth.

With continued reference to FIG. 1, package delivery address verification program 120, in the exemplary embodiment, may be a computer application on package scanning device 110 that contains instruction sets, executable by a processor. The instruction sets may be described using a set of functional modules. In exemplary embodiments, package scanning device 110 receives input from user interface 112, GPS 114, barcode scanner 116, and delivery package 130. In alternative embodiments, package delivery address verification program 120 may be a standalone program, a service, or a platform on a separate electronic device (e.g., software as a service, platform as a service, etc.), connected via network 102.

With continued reference to FIG. 1, the functional modules of package delivery address verification program 120 include first receiving module 122, second receiving module 124, comparing module 126, and displaying module 128.

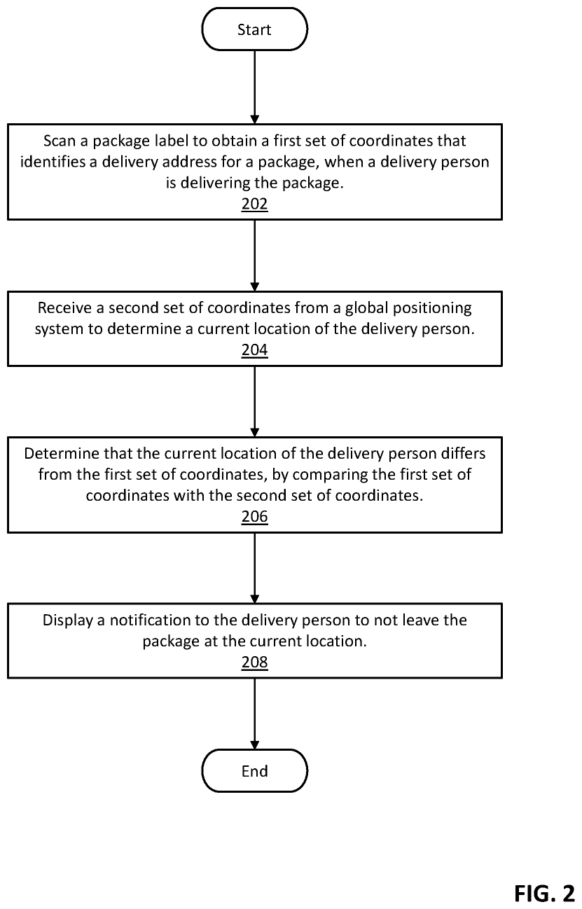

FIG. 2 is a flowchart illustrating the operation of package delivery address verification program 120 of FIG. 1, in accordance with embodiments of the present invention.

With reference to FIGS. 1 and 2, first receiving module 122 includes a set of programming instructions, in package delivery address verification program 120, to scan a package label, such as barcode label 132, to obtain a first set of coordinates that identifies a delivery address for delivery package 130, when a delivery person is delivering the delivery package 130 (step 202). The set of programming instructions is executable by a processor. In exemplary embodiments, first receiving module 122 receives the first set of coordinates that identifies a delivery address for a delivery package 130 embedded on the barcode label 132 itself by scanning the barcode label 132. For example, if the address on a delivery package 130 is 123 Main Street, New York, N.Y., then the longitudinal and latitudinal coordinates for 123 Main Street, New York, N.Y. may already be incorporated into the barcode label 132.

In alternative embodiments, scanning barcode label 132 to obtain a first set of coordinates that identifies a delivery address for a delivery package 130 may include downloading the first set of coordinates from a server over network 102. For example, the longitudinal and latitudinal coordinates for 123 Main Street, New York, N.Y. may be retrieved from a cloud server in real-time, thus enabling a delivery address on a delivery package 130 to be updated at any time prior to delivery.

With reference to an illustrative example, Joe is a driver for a well-known package delivery service provider and has a truckload full of delivery packages 130. One of the delivery packages 130 is a tent intended to be delivered to Steve Camper at 613 Lois Lane, Louisville, La. Joe pulls up to 613 Lois Lane, grabs delivery package 130 from the truck, walks up to Steve Camper's door and scans delivery package 130 with package scanning device 110. The address for the delivery package 130 (i.e., the first set of coordinates) grabbed from the truck appears on package scanning device 110 as 618 Lois Lane, Louisville, La. The first set of coordinates (i.e., the delivery address) does not match the actual location of Joe. However, Joe is in a rush to complete his route and may not notice this disparity, or Joe may accidentally read the number on Steve Camper's house as being 618 Lois Lane instead of 613 Lois Lane. As such, there is a great chance that Joe will leave the incorrect delivery package 130 at Steve Camper's door.

In various embodiments, as discussed above, package delivery address verification program 120 may be capable of updating a delivery address for the delivery package 130 prior to delivery, and sending a notification to the delivery person to deliver the delivery package 130 to the updated delivery address, if the updated delivery address is on a current route. By receiving a notification on package scanning device 110, the delivery person may save time on the delivery route by avoiding the previous delivery address that has been updated.

In alternative embodiments, a delivery person may receive notification of an updated delivery address for a delivery package 130 after the delivery person scans the barcode label 132 at the time of delivery. A received notification may be a call, a vibration, a flashing light, a displayed message, or any other form of communication, or signal, to the delivery person via package scanning device 110, a mobile device, a smart phone, a beeper, or any other electronic device capable of transmitting an electronic message or signal.

In alternative embodiments, package delivery address verification program 120 may send a notification to the delivery person to bring the delivery package 130 back to a distribution center for delivery to the updated delivery address. For example, if the updated delivery address is not on a current route of the delivery person or is in a different zip code or state, then the delivery package 130 would need to be brought back to the package delivery service provider's distribution center for reassignment to a correct route. In this fashion, a customer derives a benefit of avoiding an inadvertent, or changed, delivery of a delivery package 130 up until the point of actual delivery.

With continued reference to the illustrative example above, Steve Camper may decide that it is more convenient to have his tent delivered directly to the campground site which is located two hours north of 613 Lois Lane, however the tent is already on the delivery truck ready to be delivered. Steve Camper changes the delivery address, via the online retailer website. If the delivery package 130 has not yet been delivered, package delivery address verification program 120 may send a notification to Joe, via package scanning device 110, to bring the delivery package 130 back to a distribution center for reassignment to a delivery route for the campground site. In exemplary embodiments, the alert may also contain the date and time of the updated address, as well as automatically remove the delivery package 130 from Joe's delivery route.

With continued reference to FIGS. 1 and 2, second receiving module 124 includes a set of programming instructions in package delivery address verification program 120, to receive a second set of coordinates from a global positioning system, such as GPS 114, to determine a current location of the delivery person (step 204). In exemplary embodiments, the second set of coordinates provide longitudinal and latitudinal coordinates for a delivery person.

In exemplary embodiments, package scanning device 110 contains an enabled GPS 114. This feature allows the package scanning device 110 to provide an accurate location of the delivery at the time of scan prior to leaving a delivery package 130 at a recipient's door. In other embodiments, the delivery person's cell phone, or mobile device, may contain a GPS 114.

In exemplary embodiments, the second set of coordinates are received at the same time that the first set of coordinates are received. For example, when the barcode label 132 is scanned, then the current location of the delivery person is obtained via GPS 114.

In alternative embodiments, the delivery vehicle may contain GPS 114. However, in embodiments where a delivery person is delivering multiple delivery packages 130 to various apartments on different floors within an apartment building, the location of the delivery truck may not provide an accurate package verification for package deliveries to specific apartments.

With continued reference to the illustrative example above, second receiving module 124 may receive Joe's GPS coordinates, as he is about to leave the incorrect delivery package 130 in front of Steve Camper's house, and identify him as being at 613 Lois Lane, Louisville, La.

With continued reference to FIGS. 1 and 2, comparing module 126 includes a set of programming instructions in package delivery address verification program 120, to determine that the current location of the delivery person differs from the first set of coordinates, by comparing the first set of coordinates with the second set of coordinates (step 206). The set of programming instructions is executable by a processor.

In exemplary embodiments, comparing module 126 determines if the first set of coordinates and the second set of coordinates match, or are within a predetermined value (e.g., within 30 feet or some other programmable pre-configuration based on environmental and/or time related factors). If they match, then a confirmation is generated on package scanning device 110 confirming that the correct delivery package 130 is being delivered to the correct delivery address. In various embodiments, the delivery person may receive a notification, via package scanning device 110, notifying that the delivery address is correct by means of a flashing display message, a beep, a vibration, or any other means known to one of ordinary skill in the art.

With continued reference to the illustrative example above, Joe scanned the barcode label 132 on the delivery package 130 and received a delivery address of 618 Lois Lane, Louisville, La. Joe is about to leave the package at Steve Camper's doorstep, but he does not receive a confirmation on his package scanning device 110 because comparing module 126 determined that the address on the delivery package 130 does not match Joe's location. Joe is standing in front of 613 Lois Lane, Louisville, La. Joe now realizes that he grabbed the wrong package off the truck.

With continued reference to FIGS. 1 and 2, displaying module 128 includes a set of programming instructions in package delivery address verification program 120, to display a notification to the delivery person to not leave the delivery package 130 at the current location (step 208). The set of programming instructions is executable by a processor.

In exemplary embodiments, displaying module 128 may notify the delivery person not to leave the delivery package 130 at an address, via package scanning device 110, by means of a flashing display message, a beep, a vibration, or any other means known to one of ordinary skill in the art.

With continued reference to the illustrative example above, Joe receives a flashing notification on his package scanning device 110 soon after he scans the barcode label 132 on the delivery package 130 in front of Steve Camper's doorstep. The flashing notification prompts Joe to double check the delivery package 130 address with his current location. Upon a closer look at the delivery package 130 address and his current location, Joe sees that the delivery package 130 that he grabbed has an address of 618 Lois Lane and he is standing in front of 613 Lois Lane. Joe returns the delivery package 130 to his delivery truck and retrieves the correct package for Steve Camper. Package delivery address verification program 120 just saved Joe, Steve Camper, the correct package recipient, and the package delivery service provider, a lot of wasted time, energy, expense, and headache in having to deal with a mixed up package delivery.

In further exemplary embodiments, package delivery address verification program 120 may prompt the delivery person with directions to the delivery address for the delivery package 130, if the current location of the delivery person differs from the first set of coordinates.

With continued reference to the illustrative example above, Joe's package scanning device 110 may display driving directions to 618 Lois Lane, the correct address for the almost-delivered delivery package 130.

In other embodiments, package scanning device 110 may display driving directions to an updated delivery address, if the updated delivery address is on the route of a delivery person. In such a case, package delivery address verification program 120 may incorporate the updated delivery address into a delivery person's delivery route, based on where the delivery person is currently on their route.

In exemplary embodiments, displaying module 128 may be capable of displaying a second notification to the delivery person to confirm a floor number when delivering to a multi-floor building. This second notification may serve as a double-check for the delivery person to confirm that the delivery package 130 is being delivered to a correct apartment when a floor level is unable to be determined via GPS 114, for example when GPS 114 is only available on the delivery vehicle parked outside a multi-story apartment complex.

In various alternative embodiments, package delivery address verification program 120 may be capable of sending the second set of coordinates to a package recipient for pick-up, if the package delivery person cannot access the delivery address, for example, if an entrance gate is locked or the delivery person cannot access a driveway due to environmental conditions, weather, downed tree, too narrow, etc. Instead of leaving a sticker advising the recipient that they missed a delivery, package delivery address verification program 120 may notify a recipient via e-mail, text message, or any other form of communication known to one of ordinary skill in the art, advising of a pick-up location for delivery package 130.

In the example embodiment, network 102 is a communication channel capable of transferring data between connected devices and may be a telecommunications network used to facilitate telephone calls between two or more parties comprising a landline network, a wireless network, a closed network, a satellite network, or any combination thereof. In another embodiment, network 102 may be the Internet, representing a worldwide collection of networks and gateways to support communications between devices connected to the Internet. In this other embodiment, network 102 may include, for example, wired, wireless, or fiber optic connections which may be implemented as an intranet network, a local area network (LAN), a wide area network (WAN), or any combination thereof. In further embodiments, network 102 may be a Bluetooth network, a WiFi network, or a combination thereof. In general, network 102 can be any combination of connections and protocols that will support communications between package scanning device 110 and delivery package 130.

FIG. 3 is a block diagram depicting components of a computing device (such as package scanning device 110 as shown in FIG. 1), in accordance with an embodiment of the present invention. It should be appreciated that FIG. 3 provides only an illustration of one implementation and does not imply any limitations with regard to the environments in which different embodiments may be implemented. Many modifications to the depicted environment may be made.

Package scanning device 110 may include one or more processors 902, one or more computer-readable RAMs 904, one or more computer-readable ROMs 906, one or more computer readable storage media 908, device drivers 912, read/write drive or interface 914, network adapter or interface 916, all interconnected over a communications fabric 918. Communications fabric 918 may be implemented with any architecture designed for passing data and/or control information between processors (such as microprocessors, communications and network processors, etc.), system memory, peripheral devices, and any other hardware components within a system.

One or more operating systems 910, and one or more application programs 911, such as package delivery address verification program 120, may be stored on one or more of the computer readable storage media 908 for execution by one or more of the processors 902 via one or more of the respective RAMs 904 (which typically include cache memory). In the illustrated embodiment, each of the computer readable storage media 908 may be a magnetic disk storage device of an internal hard drive, CD-ROM, DVD, memory stick, magnetic tape, magnetic disk, optical disk, a semiconductor storage device such as RAM, ROM, EPROM, flash memory or any other computer-readable tangible storage device that can store a computer program and digital information.

Package scanning device 110 may also include a R/W drive or interface 914 to read from and write to one or more portable computer readable storage media 926. Application programs 911 on computing device 110 may be stored on one or more of the portable computer readable storage media 926, read via the respective R/W drive or interface 914 and loaded into the respective computer readable storage media 908.

Package scanning device 110 may also include a network adapter or interface 916, such as a TCP/IP adapter card or wireless communication adapter (such as a 4G wireless communication adapter using OFDMA technology). Application programs 911 on Package scanning device 110 may be downloaded to the computing device from an external computer or external storage device via a network (for example, the Internet, a local area network or other wide area network or wireless network) and network adapter or interface 916. From the network adapter or interface 916, the programs may be loaded onto computer readable storage media 908. The network may comprise copper wires, optical fibers, wireless transmission, routers, firewalls, switches, gateway computers and/or edge servers.

Package scanning device 110 may also include a display screen 920, a keyboard or keypad 922, and a computer mouse or touchpad 924. Device drivers 912 interface to display screen 920 for imaging, to keyboard or keypad 922, to computer mouse or touchpad 924, and/or to display screen 920 for pressure sensing of alphanumeric character entry and user selections. The device drivers 912, R/W drive or interface 914 and network adapter or interface 916 may comprise hardware and software (stored on computer readable storage media 908 and/or ROM 906).

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

Referring now to FIG. 4, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 4 are intended to be illustrative only and that computing nodes 10 and cloud computing environment 50 can communicate with any type of computerized device over any type of network and/or network addressable connection (e.g., using a web browser).

Referring now to FIG. 5, a set of functional abstraction layers provided by cloud computing environment 50 (FIG. 4) is shown. It should be understood in advance that the components, layers, and functions shown in FIG. 5 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and controlling access to data objects 96.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Based on the foregoing, a computer system, method, and computer program product have been disclosed. However, numerous modifications and substitutions can be made without deviating from the scope of the present invention. Therefore, the present invention has been disclosed by way of example and not limitation.

1. A computer-implemented method for verifying a delivery of a package to a correct address, the method comprising:
scanning a package label to obtain a first set of coordinates that identifies a delivery address for a package, when a delivery person is delivering the package;
receiving a second set of coordinates from a global positioning system to determine a current location of the delivery person;
comparing the first set of coordinates with the second set of coordinates; and
displaying a notification to leave the package at the current location or to not leave the package at the current location.

2. The computer-implemented method of claim 1, further comprising:
determining that the current location of the delivery person matches the first set of coordinates; and
displaying a notification to leave the package at the current location.

3. The computer-implemented method of claim 1, further comprising:
determining that the current location of the delivery person differs from the first set of coordinates; and
displaying a notification to not leave the package at the current location.

4. The computer-implemented method of claim 3, further comprising:
prompting the delivery person with directions to the delivery address for the package.

5. The computer-implemented method of claim 1, further comprising:
displaying a second notification to confirm a floor number when delivering to a multi-floor building.

6. The computer-implemented method of claim 1, wherein scanning a package label to obtain a first set of coordinates that identifies a delivery address for a package comprises downloading the first set of coordinates from a server over a network.

7. The computer-implemented method of claim 1, further comprising:
updating the delivery address for the package prior to delivery; and
sending a notification to the delivery person to deliver the package to the updated delivery address, if the updated delivery address is on a current delivery route.

8. The computer-implemented method of claim 7, further comprising:
sending a notification to bring the package back to a distribution center for delivery to the updated delivery address.

9. The computer-implemented method of claim 1, further comprising:
if the delivery person cannot access the delivery address, sending the second set of coordinates to a package recipient for pick-up.

10. A computer program product, comprising a non-transitory tangible storage device having program code embodied therewith, the program code executable by a processor of a computer to perform a method, the method comprising:
scanning a package label to obtain a first set of coordinates that identifies a delivery address for a package, when a delivery person is delivering the package;
receiving a second set of coordinates from a global positioning system to determine a current location of the delivery person;
comparing the first set of coordinates with the second set of coordinates; and
displaying a notification to leave the package at the current location or to not leave the package at the current location.

11. The computer program product of claim 10, further comprising:
determining that the current location of the delivery person matches the first set of coordinates; and
displaying a notification to leave the package at the current location.

12. The computer program product of claim 10, further comprising:
determining that the current location of the delivery person differs from the first set of coordinates; and
displaying a notification to not leave the package at the current location.

13. The computer program product of claim 12, further comprising:
prompting the delivery person with directions to the delivery address for the package.

14. The computer program product of claim 10, further comprising:
displaying a second notification to confirm a floor number when delivering to a multi-floor building.

15. The computer program product of claim 10, wherein scanning a package label to obtain a first set of coordinates that identifies a delivery address for a package comprises downloading the first set of coordinates from a server over a network.

16. A computer system, comprising:
one or more computer devices each having one or more processors and one or more tangible storage devices; and
a program embodied on at least one of the one or more storage devices, the program having a plurality of program instructions for execution by the one or more processors, the program instructions comprising instructions for:
scanning a package label to obtain a first set of coordinates that identifies a delivery address for a package, when a delivery person is delivering the package;
receiving a second set of coordinates from a global positioning system to determine a current location of the delivery person;
comparing the first set of coordinates with the second set of coordinates; and
displaying a notification to leave the package at the current location or to not leave the package at the current location.

17. The computer system of claim 16, further comprising:
determining that the current location of the delivery person matches the first set of coordinates; and
displaying a notification to leave the package at the current location.

18. The computer system of claim 16, further comprising:
determining that the current location of the delivery person differs from the first set of coordinates; and
displaying a notification to not leave the package at the current location.

19. The computer system of claim 18, further comprising:
prompting the delivery person with directions to the delivery address for the package.

20. The computer system of claim 16, further comprising:
displaying a second notification to confirm a floor number when delivering to a multi-floor building.
